(19) United States
(12) Patent Application Publication
(10) Pub. No.: US 2022/0205802 A1
(43) Pub. Date: Jun. 30, 2022

(54) METHODS AND SYSTEMS FOR PROVIDING NAVIGATION ASSISTANCE

(71) Applicant: HERE Global B.V., Eindhoven (NL)

(72) Inventor: Brad KESERICH, Chicago, IL (US)

(21) Appl. No.: 17/136,973

(22) Filed: Dec. 29, 2020

(51) Int. Cl. G01C 21/36; G10L 15/20; G06N 20/00

(52) U.S. Cl. CPC G01C 21/3629; G10L 15/20; G10L 2015/228; G06N 20/00; G01C 21/3608

(57) ABSTRACT

The disclosure provides a method, a system, and a computer program product for providing navigational assistance. The method comprises receiving speech input data from at least one user. The method may include determining, using a machine learning model, context data associated with the speech input data from the at least one user. The method further includes, determining, based on the context data, an output data for the at least one user, wherein the output data comprises behavioural data associated with the context data. The method also includes, determining, based on speech input data and the context data, a time period to transmit the output data and providing the navigational assistance to the at least one user, based on the determined output data and the determined time period.

### TECHNOLOGICAL FIELD

The present disclosure generally relates to routing and navigation applications, and more particularly relates to systems and methods for providing navigational assistance.

### BACKGROUND

Various navigation applications are available to provide assistance, for example directions for driving, walking, or other modes of travel. Web-based and mobile app-based systems offer navigation applications that allow a user to request directions from one point to another. While providing navigation instructions in response to the request of the user, it is often the case that the digital assistant of the navigational application shouts or interrupts navigation instructions at the user of the vehicle even if the user is in middle of conversation with other passenger in the vehicle or talking on a mobile phone. Sometimes, the digital assistant also interrupts the user when the user is listening to music, reading, or listening to playback of an audio book and the like.

Therefore, there is a need for a better system for providing navigational instructions to the user.

### BRIEF SUMMARY

Accordingly, there is a need for providing navigational instructions to the user in a polite, courteous, and context aware manner. In order to provide navigational instructions to the user in a polite and courteous manner, it is important to understand the context data of the speech input given by the user. To this end, there is a need to train the digital assistant with user voice, user behavior, user preferences of routes and the like. Especially, in the context of navigation assistance for autonomous vehicles and semi-autonomous vehicles, it is important that the digital assistance provided is real-time and in a polite manner. Accordingly, there is a need for a digital assistant which makes the user feel as if the user is assisted by a person. Example embodiments of the present disclosure provide a system, a method, and a computer program product for providing such navigational assistance.

Some example embodiments disclosed herein provide a method for providing navigational assistance. The method comprises receiving speech input data from at least one user. The method may include determining, using a machine learning model, context data associated with at least the speech input data. The method may further include determining, based on the context data, an output data for the at least one user, wherein the output data comprises behavioral data associated with the context data. The method may further include determining, based on speech input data and the context data, a time period to transmit the output data and providing the navigational assistance to the at least one user, based on the determined output data and the determined time period.

According to some example embodiments, the behavioral data associated with the context data comprises at least one of a politeness data factor, a graceful delivery data factor, a context awareness data factor, a professionalism data factor, a tone data factor, and a verbiage data factor.

According to some example embodiments, the context data comprises environment context data, wherein the environment context data comprises data associated with one or more background conditions in a user environment. For example, the user environment may be a vehicle in which the user is travelling.

According to some example embodiments, the navigational assistance comprises providing the output data comprising a navigation instruction, wherein the navigation instruction is at least one of an audio based navigation instruction and a visual based navigation instruction, and wherein the navigation instruction is also at least one of a polite instruction, a gently delivered instruction, or a combination thereof.

According to some example embodiments, the speech input data is associated with a plurality of activities associated with the at least one user.

According to some example embodiments, the plurality of activities are associated with at least one of an active audio conversation session data between an apparatus configured for providing the navigation assistance and the at least one user, an active audio conversation session data between a first user and a second user, an audio music, and an audio book.

According to some example embodiments, the machine learning model is trained on the context data associated with the speech input data from the at least one user.

According to some example embodiments, the context data comprises one or more of a user behavior, user activity logs, user profile data, user voice analysis data, user navigational preference data, user calendar data and application usage pattern data.

According to some example embodiments, the machine learning model is updated based on a real time change in the context data associated with the at least one user.

According to some example embodiments, the output data comprises at least one of a polite instruction to the at least one user based on the determined context data, delay in instruction based on the determined time period and context data, and urgent instruction.

According to some example embodiments, the machine learning model is at least one of a trained deep learning machine learning model or a federated machine learning model.

Some example embodiments disclosed herein provide a system for providing navigational assistance, the system comprising a memory configured to store computer-executable instructions and one or more processors configured to execute the instructions to receive speech input data from at least one user. The one or more processors are further configured to determine, using a machine learning model, context data associated with at least the speech input data. The one or more processors are further configured to determine, based on the context data, an output data for the at least one user, wherein the output data comprises behavioral data associated with the context data. The one or more processors are further configured to determine, based on speech input data and the context data, a time period to transmit the output data and provide the navigational assistance to the at least one user, based on the determined output data and the determined time period.

Some example embodiments disclosed herein provide a computer programmable product comprising a non-transitory computer readable medium having stored thereon computer executable instruction which when executed by one or more processors, cause the one or more processors to carry out operations for providing navigational assistance, the operations comprising receiving speech input data from at least one user. The operations further comprise determining, using a machine learning model, context data associated with at least the speech input data. The operations further comprise determining, based on the context data, an output data for the at least one user, wherein the output data comprises behavioral data associated with the context data. The operations further comprise determining, based on speech input data and the context data, a time period to transmit the output data and providing the navigational assistance to the at least one user, based on the determined output data and the determined time period

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a network environment of a system for providing navigation assistance, in accordance with an example embodiment;

FIG. 2 illustrates a block diagram of a system for providing navigational assistance, in accordance with an example embodiment;

FIG. 3 illustrates a block diagram of an architecture for the system and the mapping platform for providing navigational assistance, in accordance with an example embodiment;

FIG. 4 illustrates a block diagram of different steps for providing navigational assistance, in accordance with an example embodiment;

FIG. 5 illustrates an exemplary scenarios of a working example of the system for providing navigational instructions, in accordance with an example embodiment; and

FIG. 6 illustrates a flow diagram of a method for providing navigational instructions, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “route” may be used to refer to a path from a source location to a destination location on any link.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car, or autonomous car. For example, the vehicle may have zero passengers or passengers that do not manually drive the vehicle, but the vehicle drives and maneuvers automatically. There can also be semi-autonomous vehicles.

The term “machine learning model” may be used to refer to a computational or statistical or mathematical model that is based in part or on the whole on artificial intelligence and deep learning techniques. The “machine learning model” is trained over a set of data and using an algorithm that it may use to learn from the dataset.

The term “federated learning” may be used to refer to a learning technology based on use of deep neural networks on a user's private data without exposing it to the rest of the world.

### End of Definitions

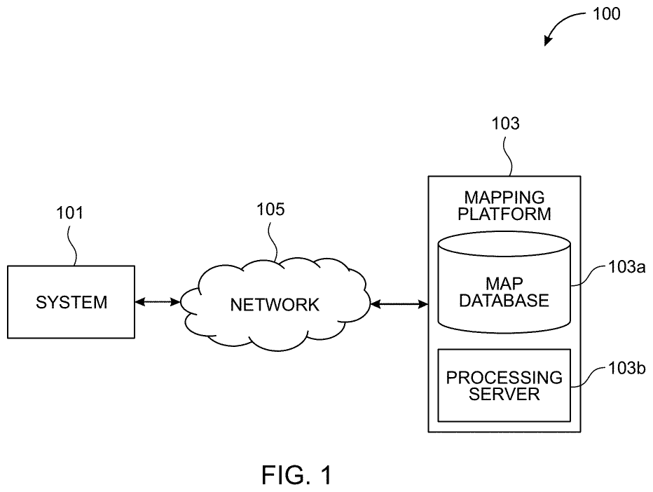

Embodiments of the present disclosure may provide a system, a method, and a computer program product for providing navigational assistance. Often times, the navigational instructions are provided by an apparatus, also interchangeably referred to hereinafter as, a digital assistant (such as a navigational assistance providing apparatus) which may interrupt the user when the user is in middle of some discussion. Further, sometimes the navigational instructions provided by such a digital assistant are rude and awkward. Accordingly, there is a need for a digital assistant that may understand the context and behavior of the user and provide instructions in a polite, courteous, and graceful manner, so as to be more human-like in providing navigational assistance services. The system, the method, and the computer program product facilitating providing navigational assistance in such an improved manner are described with reference to FIG. 1 to FIG. 6 as detailed below.

FIG. 1 illustrates a block diagram of a network environment 100 of a system 101 providing navigational assistance, in accordance with an example embodiment. The system 101 may be communicatively coupled to a mapping platform 103 via a network 105. The components described in the network environment 100 may be further broken down into more than one component such as one or more sensors or application in the system 101 and/or combined together in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud based service or a cloud based platform. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. Further, in one embodiment, the system 101 may be a standalone unit configured to provide navigational assistance. Alternatively, the system 101 may be coupled with an external device such as the autonomous vehicle. In an embodiment, the system 101 may also be referred to as a user equipment (UE). In some example embodiments, the system 101 may be any user accessible device such as a mobile phone, a smartphone, a portable computer, and the like that are portable in themselves or as a part of another portable/mobile object such as a vehicle. The system 101 may comprise a processor, a memory, and a communication interface. The processor, the memory and the communication interface may be communicatively coupled to each other. In some example embodiments, the system 101 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the system 101 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of system 101. Additional, different, or fewer components may be provided. For example, the system 101 may be configured to execute and run mobile applications such as a messaging application, a browser application, a navigation application, and the like. For example, system 101 may be a dedicated vehicle (or a part thereof) for gathering data for development of the map data in the database map 103a. For example, the system 101 may be a consumer vehicle (or a part thereof). In some example embodiments, the system 101 may serve the dual purpose of a data gatherer and a beneficiary device. The system 101 may be configured to capture sensor data associated with a road which the system 101 may be traversing. The sensor data may for example be image data of road objects, road signs, or the surroundings (for example buildings). The sensor data may refer to sensor data collected from a sensor unit in the system 101. In accordance with an embodiment, the sensor data may refer to the data captured by the vehicle using sensors.

The mapping platform 103 may comprise a map database 103a for storing map data and a processing server 103b. The map database 103a may include data associated with one or more of a road signs, or speed signs, or road objects on the link or path. Further, the map database 103a may store node data, road segment data, link data, point of interest (POI) data, link identification information, heading value records, or the like. Also, the map database 103a further includes speed limit data of each lane, cartographic data, routing data, and/or maneuvering data. Additionally, the map database 103a may be updated dynamically to cumulate real time traffic conditions. The real time traffic conditions may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. In one embodiment, the map database 103a may further store historical traffic data that includes travel times, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the system 101. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in the system 101 to provide navigation and/or map-related functions. For example, the map database 103a may be used with the system 101 to provide an end user with navigation features. In such a case, the map database 103a may be downloaded or stored locally (cached) on the system 101.

The processing server 103b may comprise processing means, and communication means. For example, the processing means may comprise one or more processors configured to process requests received from the system 101. The processing means may fetch map data from the map database 103a and transmit the same to the system 101 via an OEM cloud in a format suitable for use by the system 101. In one or more example embodiments, the mapping platform 103 may periodically communicate with the system 101 via the processing server 103b to update a local cache of the map data stored on the system 101. Accordingly, in some example embodiments, the map data may also be stored on the system 101 and may be updated based on periodic communication with the mapping platform 103.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example, the mapping platform 103 may be integrated into a single platform to provide a suite of mapping and navigation related applications for OEM devices, such as the user devices and the system 101. The system 101 may be configured to communicate with the mapping platform 103 over the network 105. Thus, the mapping platform 103 may enable provision of cloud-based services for the system 101, such as, storing the lane marking observations in an OEM cloud in batches or in real-time.

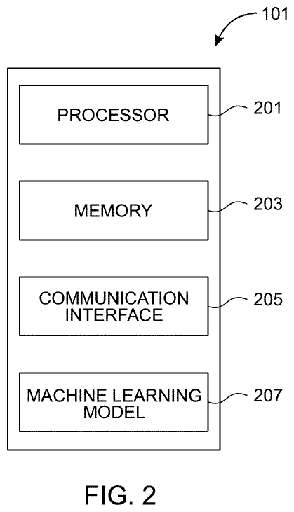

FIG. 2 illustrates a block diagram of a system 101 for providing navigational assistance, in accordance with an example embodiment. The system 101 may include a processing means such as at least one processor 201 (hereinafter, also referred to as “processor 201”), storage means such as at least one memory 203 (hereinafter, also referred to as “memory 203”), and a communication means such as at least one communication interface 205 (hereinafter, also referred to as “communication interface 205”) and a machine learning model 207. The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the system 101 or any other component with which the system 101 may communicate. The communication interface 205 may be any means such as a device or circuitry embodied in either hardware or a combination of hardware and software that is configured to receive and/or transmit data to/from a communications device in communication with the system 101. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms. In some embodiments, the communication interface 205 may enable communication with a could based network to enable federated learning, such as using the machine learning model 207.

The machine learning model 207 may refer to learning of the data to determine certain type of pattern based on some particular instructions or machine learning algorithm. The machine learning model 207 may include Deep Neural Network (DNN) that includes deep learning of the data using a machine learning algorithm. The purpose of DNN is to predict the result which otherwise are given by human brain. For this purpose, the DNN is trained on large sets of data. In an example embodiment, the system 101 may also use a federated learning model for training the dataset for the DNN. For example, the machine learning model 207 may a federated learning model. In an embodiment, federated learning basically allows training deep neural networks on a user's private data without exposing it to the rest of the world. Additionally, federated learning may allow for deep neural networks to be deployed on a user system, such as the system 101, and to learn using their data locally.

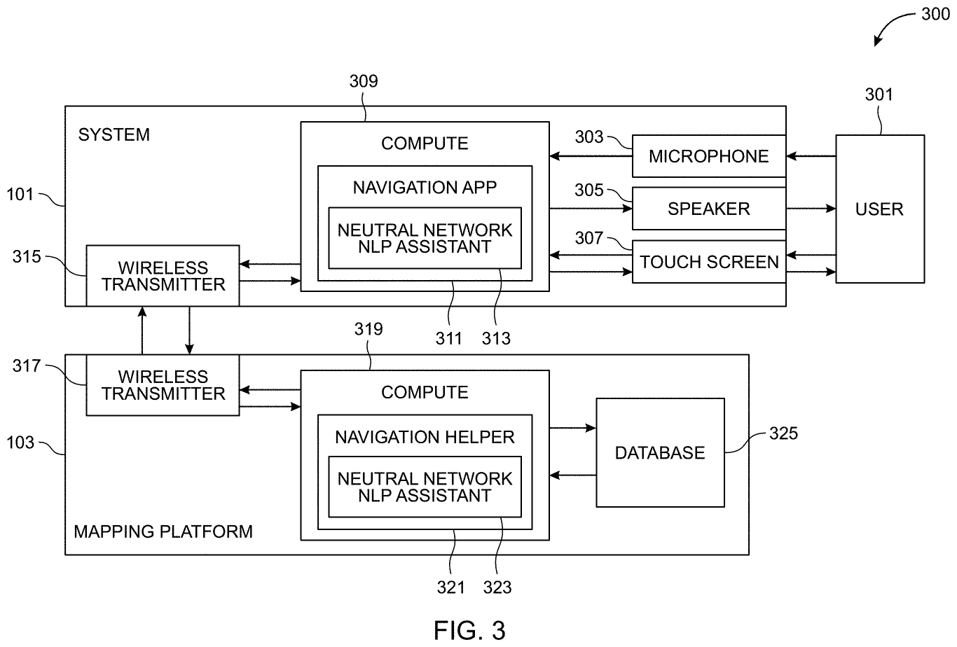

In some embodiments, the machine learning model 207 is embodied within the processor 201, and the representation shown in FIG. 2 is for exemplary purpose only. The machine learning model 207 may provide the necessary intelligence needed by the system 101 for providing a context aware navigational assistance, using the architecture shown in FIG. 3.

FIG. 3 illustrates a block diagram 300 of the system and the mapping platform for providing navigational assistance, in accordance with an example embodiment. The block diagram 300 may include an in vehicle device which is similar to the system 101 in communication with a user 301. The system 101 (or also interchangeably the in-vehicle device) may include a microphone 303, a speaker 305, a touch screen 307, a compute component 309 of the system 101, a navigation app 311, a neural network NLP assistant 313 and a wireless transmitter 315. Further, the system 101 is in communication with the mapping platform 103 which may include a wireless transmitter 317, a cloud compute component 319, in mapping platform 103, a navigation helper 321, a neural network NLP assistant 323, and a database 325 in mapping platform 103.

In various embodiments, the system 101 may be the in-vehicle device. In some embodiments, the user 301 may be a traveler, a rider, a pedestrian, and the like. In some embodiments, the user 301 may be or correspond to an autonomous or a semi-autonomous vehicle. The components such as the microphone 303, the speaker 305, and the touch screen 307 may be used as the communication interface 205. The microphone 303 may receive voice command or speech input by the user 301. In an embodiment, the user 301 gives instruction on the touch screen 307. In an embodiment, the user 301 may want to know the route or navigational information and for this purpose the user 301 may either give voice command or set destination location in an application using the touch screen 307. The system 101 may give output data to the user 301 by using speaker 305. In an example embodiment, the output data may comprise navigational instructions, audio music, audio book.

In an embodiment, the system 101 may provide digital assistance using edge computing. In some embodiments, the compute component 309 of the system 101 may be embodied in as a processor 201 in number of different ways. The compute component 309 may be configured to perform different operations, algorithms, and functions on the user input data received by the microphone 303 and the touchscreen 307. For example, the microphone 303 may receive speech input data from the user 301. The microphone 303 may also receive the surrounding data of the user's vehicle. For example, it may be a background music track, an audio book, a movie, conversation and the like. In an embodiment, the compute component 309 of the system 101 may include memory resource, storage resource, and network resources. To that end, the compute component 309 may be same as the system 101 shown in FIG. 2.

In an embodiment, the system 101 may provide digital assistance using cloud computing. In an embodiment, the compute component 309 may also include the navigational application 311 used by the user 301 for digital assistance. In an example embodiment, the system 101 may receive user 301 inputs for navigation via the navigational application 311 for route information. Additionally, or alternatively, the compute component 309 may include one or more processors capable of processing large volumes of workloads and operations to provide support for user data analysis using neural network and NLP assistance 313. The neural network NP assistant may be a part of the machine learning model 207 illustrated in FIG. 2, for providing deep learning and federated learning capabilities for providing context aware navigational assistance. In an embodiment, the compute component 309 is embodied as an executor of software instructions, the instructions may specifically configure the compute component 309 to perform the algorithms and/or operations described herein when the instructions are executed.

In an embodiment, the system 101 may transmit the stored data from wireless transmitter 315 to wireless transmitter 317 of the mapping platform 103. In an embodiment, the mapping platform 103 may be implemented as a cloud based server or a remote server. In the present invention, the mapping platform 103 is implemented as a cloud based server. The mapping platform 103 may also perform all the computing functions or operations using the cloud compute component 319. In an embodiment, the cloud compute component 319 may further include navigation helper 321 for providing navigation help to the user 301. Navigation helper 321 may be embodied as a processor in itself, or as a processor of instructions in a memory. For example, the navigation helper 321 may be envisaged as the processing server 103b of the mapping platform 103. Navigation helper 321 may include a sub-set of instructions configured to provide navigational assistance function by the cloud compute component 319. These instructions may include such as instructions for enabling provision of route guidance information, time of arrival information for user destination, politely delivered instructions and the like. The cloud compute component 319 includes neural network natural language processing (NLP) assistant 323 to perform different algorithm and/or operations on the input data of the user 301 or the data stored in the database 325. In an embodiment, the input data may be stored in the mapping platform 103 after using the input data as a training dataset for the DNN discussed earlier. The system 101 may retrieve the stored data from the system 101 or the mapping platform 103, use it to train the DNN, and further use the trained DNN to provide the output data for the user, which is used to provide user context based, human behavior emulated, polite and courteous delivery of instructions from the digital assistant, that is the system 101. That is to say, the output data comprises behavioral data associated with the context. The behavioral data may be based on various parameters or factors of speech. These factors include such as a politeness data factor, a tone data factor, and a verbiage data factor. The politeness data factor may be used to assess the polite terms needed in delivery of output data, such as words like “Excuse me”, “Please” and “Thank you”. Thus, the user 301 experiences very pleasing and gentle service provided by the system 101, which is more personalized and humane, unlike the monotonous and sometimes even rude assistance provided by digital assistant devices known in the art. Thus, the system 101 is able to provide a very high quality user experience as compared to other similar technologies that already exist in the art. Further, the system 101 may provide digital assistance, such as navigational assistance, by edge computing or cloud computing technology or both, as may be desirable according to user conditions, preferences, and limitations.

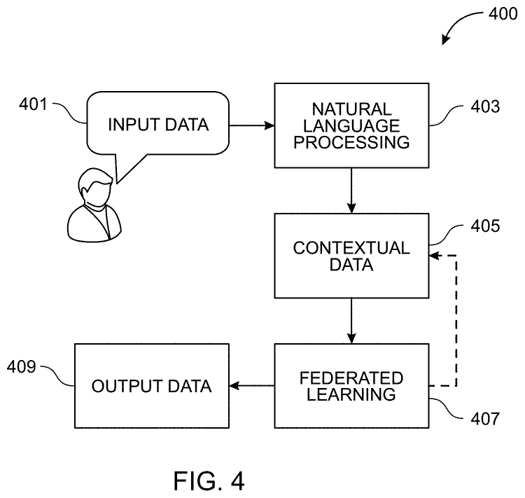

FIG. 4 illustrates a block diagram 400 of different steps for providing navigational assistance, in accordance with an example embodiment. Starting at block 401, the system 101 may be configured to obtain input data from the user 301. In an embodiment, the input data may be speech data of the user 301. In an embodiment, the speech data may be, but not limited to, one or more of a voice command given by a user, conversation of the user 301 with another passenger in the system 101 (hereinafter, the system 101 may also be referred to as the vehicle), conversation of the user 301 on mobile phone, audio of music, audio of a book and the like.

At block 403, the system 101 may further understand and analyze the language and speech data of the user 301 using Natural language Processing (NLP) algorithms. The system 101 may also obtain the environment context data of the user 301, such as user background environment information of the user. Based on the speech input data and the environmental data in the vehicle, the system 101 may determine the context associated with the speech input data. In an example embodiment, the system 101 may determine behavior of the user such as if the user is happy, or sad, or frustrated, or in urgency, or busy in listening to music, or audio book based on the speech input data

At block 405, the system 101 may determine the context data that may further comprise one or more of a user behavior, user activity logs, user profile data, user voice analysis data, user navigational preference data, user calendar data and application usage pattern data. In an embodiment, the context data comprises environment context data, wherein the environment context data comprises data associated with one or more background conditions in a user environment. For example, the user 301 may want navigational assistance at 8:00 am in morning, then the system 101 may analyze, using historical data stored in map database 325 and the NLP assistant 323, that the user is in hurry as today the user is running late as this is little late than the routing time at which user used to go to office on weekdays. Similarly, if the user is in conversation with another passenger in the vehicle or talking on mobile phone, then based on the speech input data and the environmental context data, the system 101 may determine that the user is in important conversation and is busy.

At block 407, the system 101 may further take the context data as input for learning the user behavior, mood, user preferences, user profile and the like. The system 101 may learn the context data using Deep Neural Network (DNN). In an embodiment, the system 101 may use federated machine learning model in DNN to learn the context of the input data. In an embodiment, the federated machine learning model is updated based on a real time change in the context data associated with the input. For example, the system 101 may learn the user voice and user profiles of all the users who drive the same vehicle using DNN. For example, more than one person in family may drive the same vehicle and in that case the system 101 may learn the user voice of all the users. The system 101 may also learn the most frequently followed routes. For example, the system 101 may learn the days on which the user 301 goes to office and routes along with the timings of going and coming back office. In an example embodiment, the system 101 may also learn the pattern followed by the user 301 for shopping. Based on the determined context data, the system 101 may determine the time period after which the system 101 may provide navigational instruction to the user 301. For example, if the user 301 is busy in some conversation and there is a crucial turn ahead, and then the system 101 may politely give navigation instruction to the user 301. If the user 301 is busy and there is no important instruction, then the system may wait for some time to provide polite navigational instruction only when it is needed. The system 101 may provide the updated learned data back to the context data set at 405, for continuous self-learning and model improvement.

At block 409, the system 101 may provide output data to the user 301, in the form of polite digital assistance as output data. The output data comprises behavioral data associated with the context data. In an embodiment, the behavioral data associated with the context data comprises at least one of a politeness data factor, a graceful delivery data factor, a context awareness data factor, a professionalism data factor, a tone data factor, and a verbiage data factor. The output data provided to the user is in a very polite and graceful manner. The system 101 may understand the context of the user and based on the context data, it provides the output to the user 301. For example, while driving the vehicle, when the user 301 is in conversation with the other passenger, then based on the NLP and DNN algorithm, the system 101 may determine and predict that the route followed by the user 301 is for going to office and also the user is on time, then system 101 may not interrupt in the conversation between the user 301 and the passenger for providing navigational instruction.

Similarly, when the user 301 is getting late for an important meeting, the system 101 may determine that the user 301 is in a hurry for office based on the speech input data and learned data, and simultaneously, the user 301 is in conversation with the other passenger, then the system 101 may provide navigational instruction in a polite manner and use polite language like “Excuse me” and/or “Please” and provide polite and graceful navigational instruction. Similarly, when a user is listening to audio music and there is a turn ahead on the route, if the system 101 determines that the user is not in urgency based on the context information and the speech input data, the system 101 may keep quiet and may not provide any navigational instruction to the user.

Similarly, if the system 101 learns that the user typically does not like having conversations interrupted and its assigned user confirms to that expectation then the system 101 may categorize the navigational instruction in two scenarios. The first scenario may be time critical and the other non-critical. The time critical scenario may be that the user is late for a job interview and this is seen scheduled in the user calendar that is stored in the database 103a. If the digital assistant has access to this information and sees that if the upcoming turn is missed then the user may definitely miss the meeting, then the system 101 may politely instruct the user informing the user about urgent turn. On the other hand, if the travel scenario is non-critical, like the user is heading out to get groceries, and a missed turn will not be overly time costly, then the system 101 may tend to let the user finish the conversation. In this way, the digital assistant, such as the system 101 is configured for providing navigational assistance seems more like a personal assistance. In another embodiment, the output provided by the system 101 may be a text message notification when not very urgent or a video with avatar in it.

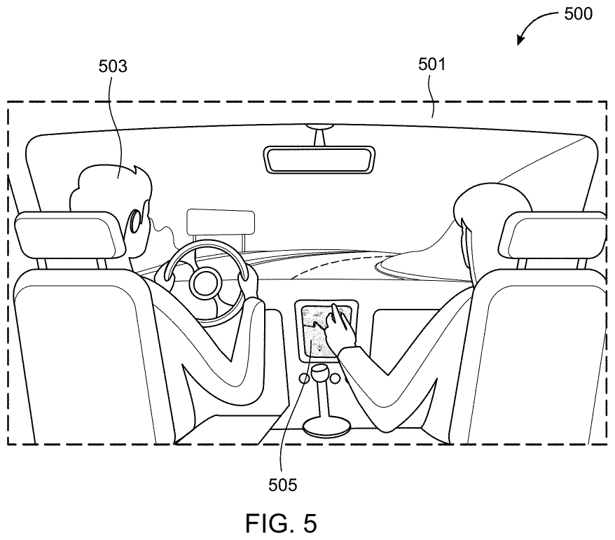

FIG. 5 illustrates an exemplary scenario of a working example of the system 101 for providing navigational instructions, in accordance with an example embodiment. There is shown a vehicle 501, a user 503 (similar to the user 301) and an in-vehicle device 505 in the FIG. 5. When the user 503 requests for navigational information to the in-vehicle device 505, the system 101 may trigger and take the speech data of the user 503 as input. The system 101 may further determine context of the speech input data of the user 503 by applying natural language processing algorithm on the speech input data. In an embodiment, the system 101 may determine the behavior of the user 503. In another embodiment, the system 101 may further determine if the user 503 is in conversation with other passenger in the vehicle 501 or not. And the system 101 may also determine if there is any background music or audio book. Further, the determined context data is provided to pre-trained machine learning model. In an embodiment, the pre-trained machine learning model may be deep neural network using federated learning algorithms, as discussed earlier. In an embodiment, the machine learning model is updated in real time based on the change in context data. The system 101 further provides output to the user 503 based on the output of the machine learning model. In an embodiment, the system 101 may provide navigational instructions to the user 503 in a polite and graceful manner. For example, the system 101 may provide navigational instruction as ‘Excuse me Please, you need to take right turn after 100 meters. In another embodiment, the output provided by the system 101 may be to not intervene and keep quiet if the user is in important conversation with the other passenger. Thus, the system 101 is configured for providing navigational assistance to the user based on context awareness of user's environment, and subsequently, delivering navigational assistance in personalized, graceful, polite, courteous and time sensitive manner.

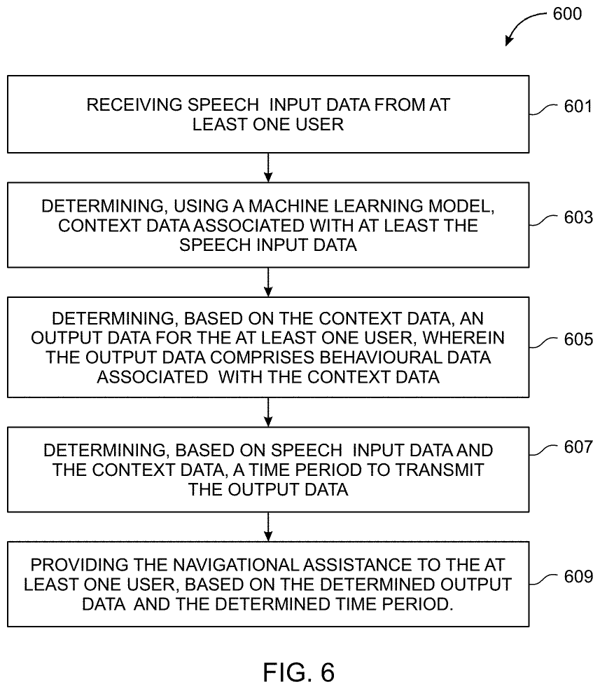

FIG. 6 illustrates a flow diagram of a method 600 for providing navigational assistance, in accordance with an example embodiment. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 600 illustrated by the flowchart diagram of FIG. 6 is used for providing navigational instructions. Fewer, more, or different steps may be provided.

At step 601, the method 600 comprises receiving speech input data from at least one user. The speech input data is associated with a plurality of activities associated with the at least one user. The plurality of activities are associated with at least one of an active audio conversation session data between a navigation assistance apparatus, such as the system 101, and the at least one user, an active audio conversation session data between a first user and a second user, an audio music, an audio book. At step 603, the method 600 comprises determining, using a machine learning model, context data associated with the speech input data from the at least one user. For example, the system 101 uses the machine learning model 207 to learn the speech data of the user and determining the context data for the speech data of the user. The context data may be data about user preferences, user conversations, user environment and the like, as previously disclosed. The machine learning model 207 is trained on the context data associated with the speech input data from the at least one user and the machine learning model 207 is also updated based on a real time change in the context data. In an embodiment, the context data comprises one or more of the user behavior, user activity logs, user profile data, user voice analysis data, user navigational preference data, user calendar data and application usage pattern data. In another embodiment, the context data comprises environment context data, wherein the environment context data comprises data associated with one or more background conditions in a user environment.

At step 605, the method 600 comprises determining, based on the context data, an output data for the at least one user, wherein the output data comprises behavioral data associated with the context data. The behavioral data associated with the context data comprises at least one of a politeness data factor, a graceful delivery data factor, a context awareness data factor, a professionalism data factor, a tone data factor, and a verbiage data factor. The output data may be comprise a navigation instruction, wherein the navigation instruction is at least one of an audio based navigation instruction and a visual based navigation instruction. In some embodiments, the navigation instruction is also at least one of a polite instruction, a gently delivered instruction, an urgent instruction, a null instruction. The output data is thus used for providing graceful, personalized and courteous navigation instructions.

At step 607, the method 600 comprises determining, based on speech input data and the context data, a time period to transmit the output data. For example, the time period may be used to determine a delay in delivery of navigation instruction. This may happen when a user is in the middle of an active conversation session. The system 100 may be able to determine this on the basis of the context data and the speech input data, and then based on machine learning, identifies that is it not an appropriate time to blurt out with the navigation instruction. Thus, the system 100 determines a time period to delay the delivery of the navigation instruction. In some embodiments, the delay is a predetermined time period. In some other embodiments, delay is identified based on the duration of time for which speech input is being received. As soon as speech input is stopped, the time period is set to duration of time elapsed, and further, navigation instruction may be delivered.

At step 609, the method 600 comprises providing the navigational assistance to the at least one user, based on the determined output data and the determined time period. The navigational assistance corresponds to polite instructions, or gentle delivery of instructions as output data to the at least one user, as discussed above.

The method 600 may be implemented using corresponding circuitry. For example, the method 600 may be implemented by an apparatus or system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 600.

In an example embodiment, an apparatus for performing the method 600 of FIG. 6 above may comprise a processor (e.g. the processor 201) configured to perform some or each of the operations of the method of FIG. 6 described previously. The processor may, for example, be configured to perform the operations (601-609) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (601-609) may comprise, for example, the processor 201 which may be implemented in the system 101 and/or a device or circuit for executing instructions or executing an algorithm for processing information as described above.

In this way, example embodiments of the invention results in providing a humanized digital assistant that may improve the user's in-vehicle experience. The invention may also provide more personal interaction with the digital assistant, that is the system 101. The invention also provides assistant that may vocalize the navigation instructions to the user. The assistant may also be able to answer questions, take commands and learn from user preferences. The invention also provides polite navigational instructions and learns from multiple users as well as specific user's expectation.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method for providing navigational assistance, the method comprising:
receiving speech input data from at least one user;
determining, using a machine learning model, context data associated with at least the speech input data;
determining, based on the context data, an output data for the at least one user, wherein the output data comprises behavioural data associated with the context data;
determining, based on the speech input data and the context data, a time period to transmit the output data; and
providing the navigational assistance to the at least one user, based on the determined output data and the determined time period.

2. The method of claim 1, wherein the behavioural data associated with the context data comprises at least one of a politeness data factor, a graceful delivery data factor, a context awareness data factor, a professionalism data factor, a tone data factor, and a verbiage data factor.

3. The method of claim 1, wherein the context data comprises environment context data, wherein the environment context data comprises data associated with one or more background conditions in a user environment.

4. The method of claim 1, wherein providing the navigational assistance comprises providing the output data comprising a navigation instruction, wherein the navigation instruction is at least one of an audio based navigation instruction and a visual based navigation instruction, and wherein the navigation instruction is also at least one of a polite instruction, a gently delivered instruction, or a combination thereof.

5. The method of claim 1, wherein the speech input data is associated with a plurality of activities associated with the at least one user.

6. The method of claim 5, wherein the plurality of activities are associated with at least one of an active audio conversation session data between a navigation assistance apparatus configured for providing the navigation assistance and the at least one user, an active audio conversation session data between a first user and a second user, playback of an audio music, and playback of an audio book.

7. The method of claim 1, wherein the machine learning model is trained on the context data associated with the speech input data from the at least one user.

8. The method of claim 7, wherein the context data comprises one or more of a user behaviour, user activity logs, user profile data, user voice analysis data, user navigational preference data, user calendar data and an application usage pattern data.

9. The method of claim 7, wherein the machine learning model is updated based on a real time change in the context data associated with the at least one user.

10. The method of claim 1, wherein the output data comprises at least one of a polite instruction to the at least one user based on the determined context data, a delay in delivery of a navigation instruction based on the determined time period and the context data, an urgent instruction, or a combination thereof.

11. The method of claim 1, wherein the machine learning model is at least one of a trained deep learning machine learning model or a federated machine learning model.

12. A system for providing navigational assistance, the system comprising:
at least one non-transitory memory configured to store computer executable instructions; and
at least one processor configured to execute the computer executable instructions to:
receive speech input data from at least one user;
determine, using a machine learning model, context data associated with at least the speech input data;
determine, based on the context data, an output data for the at least one user, wherein the output data comprises behavioural data associated with the context data;
determine, based on the speech input data and the context data, a time period to transmit the output data; and
provide the navigational assistance to the at least one user, based on the determined output data and the determined time period.

13. The system of claim 12, wherein the behavioural data associated with the context data comprises at least one of a politeness data factor, a graceful delivery data factor, a context awareness data factor, a professionalism data factor, a tone data factor, and a verbiage data factor.

14. The system of claim 12, wherein the context data comprises environment context data, wherein the environment context data comprises data associated with one or more background conditions in a user environment.

15. The system of claim 12, wherein the speech input data is associated with a plurality of activities associated with the at least one user.

16. The system of claim 15, wherein the plurality of activities are associated with at least one of an active audio conversation session of the at least one user, an active audio conversation session data between a first user and a second user, playback of an audio music, and playback of an audio book.

17. The system of claim 12, wherein the machine learning model is trained on the context data associated with the speech input data from the at least one user.

18. The system of claim 17, wherein the context data comprises one or more of a user behaviour, user activity logs, user profile data, user voice analysis data, user navigational preference data, user calendar data and an application usage pattern data.

19. The system of claim 12, wherein the output data comprises at least one of a polite instruction to the at least one user based on the determined context data, a delay in delivery of a navigation instruction based on the determined time period and the context data, an urgent instruction, or a combination thereof.

20. A computer programmable product comprising a non-transitory computer readable medium having stored thereon computer executable instruction which when executed by one or more processors, cause the one or more processors to carry out operations for providing navigational assistance, the operations comprising:
receiving speech input data from at least one user;
determining, using a machine learning model, context data associated with at least the speech input data;
determining, based on the context data, an output data for the at least one user, wherein the output data comprises behavioural data associated with the context data;
determining, based on the speech input data and the context data, a time period to transmit the output data; and
providing the navigational assistance to the at least one user, based on the determined output data and the determined time period.
